(19) United States
(12) Patent Application Publication
(10) Pub. No.: US 2021/0250277 A1
(43) Pub. Date: Aug. 12, 2021

(54) PACKET AGGREGATION METHOD APPLIED IN MULTIPLE LINK OPERATIONS OF AN ELECTRONIC DEVICE

(71) Applicant: MEDIATEK INC., Hsin-Chu (TW)

(72) Inventor: Ying-You Lin, Hsinchu City (TW)

(21) Appl. No.: 17/137,406

(22) Filed: Dec. 30, 2020

Related U.S. Application Data
(60) Provisional application No. 62/971,260, filed on Feb. 7, 2020.

(51) Int. Cl. H04L 12/709

(52) U.S. Cl. CPC H04L 45/245

(57) ABSTRACT

The invention provides a method applied in multiple link operations of an electronic device, wherein the electronic device is communicated with another electronic device by using a first link and a second link, and the method includes the steps of: determining a maximum aggregation length of a plurality of packets; using the maximum aggregation length of the plurality of packets, a data rate of the first link and a data rate of the second link to calculate a joint physical layer protocol data unit (PPDU) time; aggregating first packets of the plurality of packets in sequence to form a first aggregation based on the joint PPDU time; aggregating second packets of the plurality of packets in sequence to form a second aggregation based on the joint PPDU time; and simultaneously transmitting the first aggregation and the second aggregation by using the first link and the second link, respectively.

### CROSS REFERENCE TO RELATED APPLICATIONS

This application claims the priority of U.S. Provisional Application No. 62/971,260, filed on Feb. 7, 2020, which is included herein by reference in its entirety.

### BACKGROUND

IEEE 802.11 be defines multiple link operations that allow an access point (AP) and a station to communicate with each other by using two or more links. Due to a hardware limitation such as spacing between antennas within the station, the station can be operated in a synchronous mode or an asynchronous mode. The synchronous mode is also named as a non-STR mode, that is the station cannot transmit and receive data at the same time via multiple links, but the station needs to transmit data by using the multiple links simultaneously. The asynchronous mode is also named as a STR mode, that is the station can transmit and receive data at the same time via multiple links, but the station does not need to transmit data by using the multiple links simultaneously.

In a conventional wireless transmission of the station, packets are aggregated to form a single frame for the transmission. When the synchronous mode (non-STR mode) is used, however, the aggregation operation may have some problems. Firstly, a physical layer protocol data unit (PPDU) length can be used by the software or hardware to determine a PPDU duration boundary and scheme selection; however, how to calculate PPDU length of the multiple link operations is a problem. The second problem is that how to perform the aggregation for the PPDUs in the multiple link operations from a system view.

### SUMMARY

It is therefore an objective of the invention to provide an aggregation method for the multiple link operations to solve the above-mentioned problems.

According to one embodiment of the invention, a method applied in multiple link operations of an electronic device is disclosed, wherein the electronic device is communicated with another electronic device by using a first link and a second link, and the method comprises: determining a maximum aggregation length of a plurality of packets; using the maximum aggregation length of the plurality of packets, a data rate of the first link and a data rate of the second link to calculate a joint physical layer protocol data unit (PPDU) time; aggregating first packets of the plurality of packets in sequence to form a first aggregation based on the joint PPDU time; aggregating second packets of the plurality of packets in sequence to form a second aggregation based on the joint PPDU time; and simultaneously transmitting the first aggregation and the second aggregation by using the first link and the second link, respectively.

According to another embodiment of the invention, an electronic device is configured to perform steps of: establishing a first link and a second link to communicate with another electronic device; determining a maximum aggregation length of a plurality of packets; using the maximum aggregation length of the plurality of packets, a data rate of the first link and a data rate of the second link to calculate a joint physical layer protocol data unit (PPDU) time; aggregating first packets of the plurality of packets in sequence to form a first aggregation based on the joint PPDU time; aggregating second packets of the plurality of packets in sequence to form a second aggregation based on the joint PPDU time; and simultaneously transmitting the first aggregation and the second aggregation by using the first link and the second link, respectively.

According to another embodiment of the invention, a method applied in multiple link operations of an electronic device is disclosed, wherein the electronic device is communicated with another electronic device by using a first link and a second link, and the method comprises: receiving a plurality of packets; sequentially allocating the plurality of packets into a first aggregation and a second aggregation in an interleaving manner; and simultaneously transmitting the first aggregation and the second aggregation by using the first link and the second link, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the invention.

FIG. 2 shows the two MPDU aggregations according to one embodiment of the invention.

FIG. 3 shows the two MPDU aggregations according to another embodiment of the invention.

FIG. 4 shows a MPDU start spacing.

FIG. 5 shows the two MPDU aggregations according to another embodiment of the invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

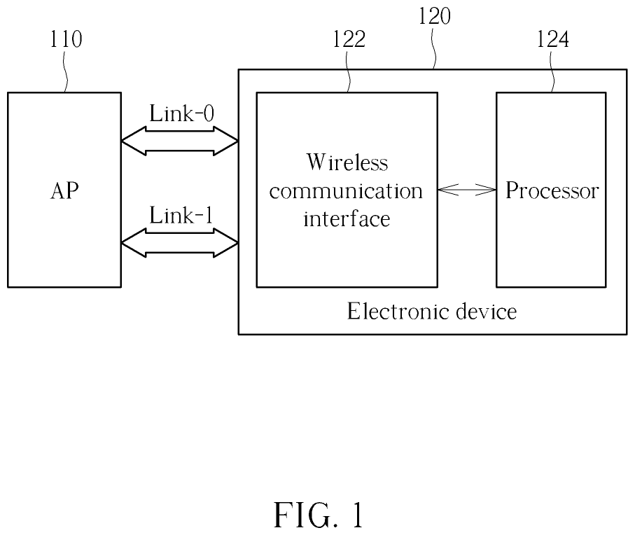

FIG. 1 is a diagram illustrating a wireless communication system according to one embodiment of the invention. As shown in FIG. 1, the wireless communication system comprises an access point (AP) 110 and an electronic device 120, wherein the electronic device 120 comprises a wireless communication interface 122 and a processor 124. In this embodiment, the electronic device 120 can be a cell phone, a tablet, a notebook, or any other electronic device capable of wirelessly communicating with the AP 110. In addition, the AP 110 and the electronic device 120 support multiple link operations in the IEEE 802.11 be specification, that is the electronic device 120 is allowed to use two or more links to communicate with the AP 110.

In this embodiment, the electronic device 120 has established two links (Link-0 and Link-1) with the AP 110. Assuming that the electronic device 120 operates under the synchronous mode (non-STR mode), when the electronic device 120 wants to send data to the AP 110, the processor 124 will generate two packet aggregations for the two links, and the two packet aggregations are sent to the AP 110 via the wireless communication interface 122 simultaneously. Specifically, the processor 114 aggregates the packets (hereinafter, a Media Access Control (MAC) Protocol Data Unit, MPDU, serves as a packet) in sequence based on a block acknowledgement (BA) window, wherein the BA window may be any suitable value such as 64, 128 or 1024 that is preset in the electronic device 120. Then, the processor 124 uses the following equation to calculate a joint PPDU time of the two links:

joint PPDU Time_{0,1}=NextMaxAMPDULength_{0,1}*(1/(RATE0+RATE1)) (1);

wherein the term ‘NextMaxAMPDULength_{0,1}’ is a length (maximum aggregation length) of the two MDPU aggregations, ‘RATE0’ is a data rate (bit rate) of Link-0, and ‘RATE1’ is a data rate (bit rate) of Link-1. After the joint PPDU time is calculated, the processor 124 can know the PPDU duration boundary, and joint PPDU time and the PPDU duration boundary can be used for the schedule arrangements to maximize the throughput.

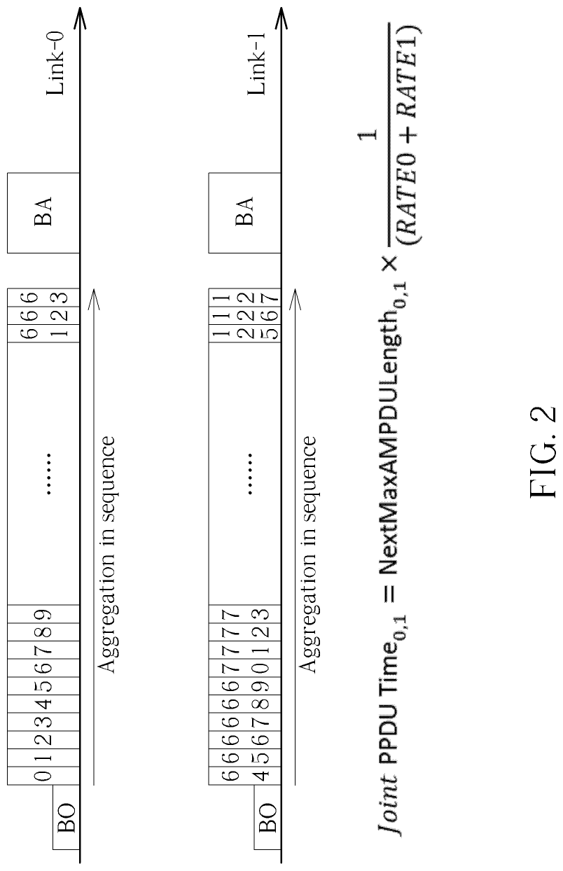

‘RATE0’ and ‘RATE1’ shown in equation (1) can be obtained by any appropriate estimation method or measurement method, so the details of the data rate of Link-0 and Link-1 are omitted here. Therefore, the joint PPDU time can be calculated if the length of the two MDPU aggregations (i.e., ‘NextMaxAMPDULength_{0,1}’) is obtained. In one embodiment, the length of the two MDPU aggregations can be obtained by using hardware circuits to record a length of each MPDU in the two MDPU aggregations; and since the processor 124 has information of the length of each MPDU, the maximum aggregation length of the two MDPU aggregations is therefore obtained. FIG. 2 shows the two MPDU aggregations according to one embodiment of the invention. In the embodiment shown in FIG. 2, it is assumed that the BA window is ‘128’, the number of the MPDU is ‘128’, each MPDU has a fixed length, and ‘RATE0’ is equal to ‘RATE1’, therefore, the first MPDU aggregation has the MPDUs with sequence numbers ‘0’-‘63’, and the second MPDU aggregation has the MPDUs with sequence numbers ‘64’-‘127’. Then, after a time countdown of a back-off (BO) time, the processor 124 simultaneously sends the first MPDU aggregation and the second MPDU aggregation to the AP 110 via the Link-0 and Link-1, respectively.

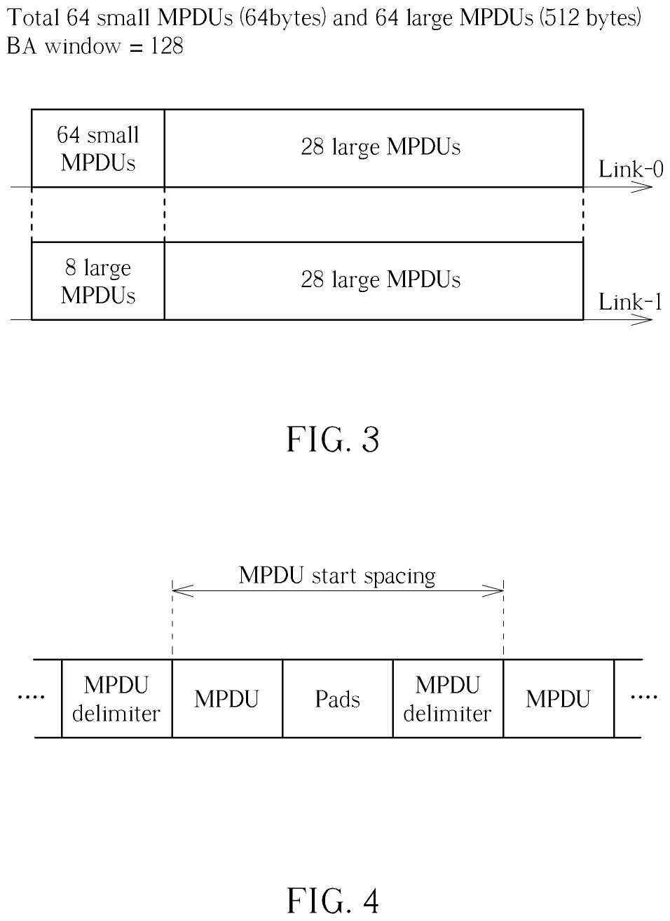

FIG. 3 shows the two MPDU aggregations according to another embodiment of the invention. In the embodiment shown in FIG. 3, it is assumed that the BA window is ‘128’, the number of the MPDU is ‘128’, sixty-four MPDUs are small MPDUs and a length of each small MPDU is 64 bytes, sixty-four MPDUs are large MPDUs and a length of each large MPDU is 64 bytes, and ‘RATE0’ is equal to ‘RATE1’. Because the length of each MPDU is known by the processor 124, the processor 124 may arrange the first MPDU aggregation to have the MPDUs with sequence numbers ‘0’-‘91’, where the MPDUs with the sequence numbers ‘0’-‘63’ are small MPDUs and the MPDUs with the sequence numbers ‘64’-‘91’ are large MPDUs; and the processor 124 may also arrange the second MPDU aggregation to have the large MPDUs with sequence numbers ‘92’-‘127’, so as to make the two MPDU aggregations have the same PPDU time.

In the above embodiments, the length of the two MDPU aggregations can be obtained by using hardware circuits to record a length of each MPDU in the two MDPU aggregations, for the determination of the length of the two MDPU aggregations (i.e., ‘NextMaxAMPDULength_{0,1}’). In another embodiment, ‘NextMaxAMPDULength_{0,1}’ can be obtained by using a total queue length and a total MPDU count of the MPDUs that are needed to be sent by using the two links. Specifically, if the number of MPDUs processed by the processor 124 is ‘MPDU_CNT’, the total length of all the MPDUs is ‘Qlen’, ‘NextMaxAMPDULength_{0,1}’ can be calculated by using the following equation:

NextMaxAMPDULength_{0,1}=(Qlen/MPDU_CNT)*(BA_win) (2);

wherein the term ‘BA_win’ is a BA window preset in the electronic device 120.

In addition, the aggregation transmission of the electronic device 230 may suffer other restrictions such as minimum MPDU start spacing (MMSS) restriction, that is the MPDU start spacing within the aggregation must be greater than the MMSS. Taking FIG. 4 as an example, the aggregation comprises a plurality of MPDUs, wherein the MPDU start spacing includes the MPDU, the pads (dummy pads) and MPDU delimiter. If the MPDU start spacing is less than the MMSS such as 10 micro-seconds, the processor 124 needs to add more pads immediately after the MPDU so as to make the MPDU start spacing be greater than the MMSS. Therefore, since the aggregation may be modified to satisfy the requirements of the MMSS, the above calculated ‘NextMaxAMPDULength_{0,1}’ may be adjusted for more accurate calculation of the joint PPDU time.

Specifically, using one MPDU prepared to be sent in LionI-0 as an example, the processor 124 determines if the length of the MPDU is less than a parameter ‘MMSSByteLen’, wherein ‘MMSSByteLen’ is obtained by using the following equation:

MMSSByteLen=MMSS*RATE0/8 (3);

and if the length of the MPDU is less than ‘MMSSByteLen’, the processor 124 adds pads after the MPDU, wherein the length of the added pads is equal to a difference between ‘MMSSByteLen’ and the length of the MPDU; and if the length of the MPDU is not less than ‘MMSSByteLen’, no additional pads are added. Therefore, ‘NextMaxAMPDULength₀’ can be modified as follows:

$${NextMaxAMPDULength}_{0} = {\sum }_{i = 0}^{Agg \_ Max} ( {Δ}_{i} + MPD {U}_{i} ) ; \qquad ( 4 )$$

wherein ‘Agg_Max’ is a maximum sequence number of the MPDU aggregation for Link-0, ‘Δ’ is the length of the additional pads added immediately after the MPDU. In addition, if ‘NextMaxAMPDULength₀’ is estimated by using the equation (2), ‘Δᵢ’ may be a difference between ‘MMSSByteLen’ and an average length of the MPDUs.

Similarly, ‘NextMaxAMPDULength₁’ can be calculated by using the steps similar to the equation (4). Then, the modified joint PPDU time can be calculated by using modified ‘NextMaxAMPDULength_{0,1}’ in equation (1).

In another embodiment, the average MPDU length is used to simplify the calculation of the modified ‘NextMaxAMPDULength_{0,1}’, wherein the average MPDU length may be calculated by using the following equation (5) or (6):

MPDU_{avg}=Qlen/MPDU_CNT (5);

MPDU_{avg}=NextMaxAMPDULength_{0,1}/MPDU_CNT (6);

then, an adjusted data rates of ‘RATE0’ and ‘RATE1’ for the MMSS (hereinafter, ‘MSRATE0’ and ‘MSRATE1’) are provided for the further calculation. In detail, if ‘MMSS*RATE0’ is greater than ‘MPDU_{avg}’, ‘MSRATE0’ is equal to ‘MPDU_{avg}/MMSS’; and if ‘MMSS*RATE0’ is less than ‘MPDU_{avg}’, ‘MSRATE0’ is equal to ‘RATE0’. Similarly, if ‘MMSS*RATE1’ is greater than ‘MPDU_{avg}’, ‘MSRATE1’ is equal to ‘MPDU_{avg}/MMSS’; and if ‘MMSS*RATE1’ is less than ‘MPDU_{avg}’, ‘MSRATE1’ is equal to ‘RATE1’.

Then, the modified ‘NextMaxAMPDULength_{0,1}’ (hereinafter, ‘Lₘₘₛₛ’) is calculated as follows:

$${L}_{m m s s} = {NextMaxAMPDULength}_{0 , 1} + {N}_{n e x t} * ( {Δ}_{0} * \frac{R A T E 0}{R A T E 0 + R A T E 1} + {Δ}_{1} * \frac{R A T E 1}{R A T E 0 + R A T E 1} ) = {NextMaxAMPDULength}_{0 , 1} + {N}_{n e x t} * \frac{M S R A T E 0}{M S R A T E 0 + MSRATE 1} * {Δ}_{0} + {N}_{n e x t} * \frac{M S R A T E 1}{M S R A T E 0 + MSRATE 1} * {Δ}_{1} ; \qquad ( 7 )$$

wherein

$$‘ {N}_{n e x t} * \frac{M S R A T E 0}{M S R A T E 0 + M S R A T E 1} ’$$

indicates the number of MPDUs in the MPDU aggregation for the Link-0, ‘Δ₀’ is a difference ‘MMSSByteLen’ and an average length of the MPDUs for Link-0,

$$‘ {N}_{n e x t} * \frac{M S R A T E 0}{M S R A T E 0 + M S R A T E 1} ’$$

indicates the number of MPDUs in the MPDU aggregation for the Link-1, and ‘Δ₁’ is a difference ‘MMSSByteLen’ and an average length of the MPDUs for Link-1.

Finally, the joint PPDU time can be calculated as follows:

joint PPDU Time_{0,1}=Lₘₘₛₛ*(1/(RATE0+RATE1)) (8).

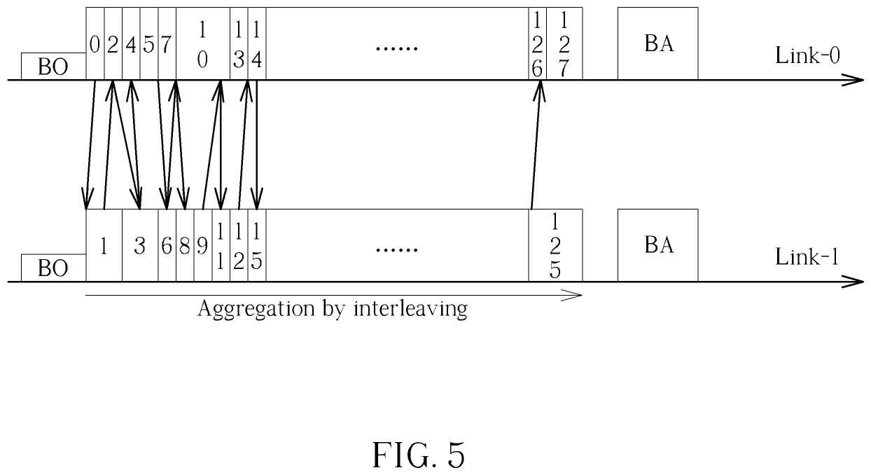

In the above embodiments shown in FIG. 2 and FIG. 3, ‘NextMaxAMPDULength_{0,1}’ is calculated for the two MPDU aggregations in Link-0 and Link-1. In another embodiment, the processor 124 may use a water-filling algorithm to perform the interleaving MPDU aggregations. Specifically, referring to FIG. 5, the processor 124 sequentially adds the MPDUs into the link with fewer accumulated airtime, for example, the MDPU with the sequence number ‘0’ is added into the aggregation of Link-0, the MDPU with the sequence number ‘1’ is added into the aggregation of Link-1 with fewer accumulated airtime, the MDPU with the sequence number ‘2’ is added into the aggregation of Link-0 with fewer accumulated airtime, the MDPU with the sequence number ‘3’ is added into the aggregation of Link-1 with fewer accumulated airtime, and so on. By using the interleaving MPDU aggregations, the electronic device 120 can have higher throughput when the MPDU lengths are not the same.

Briefly summarized, in the MPDU aggregation method used in multiple link operations of the invention, a length of a summation of two or more MDPU aggregations is calculated or estimated for the calculation of a joint PPDU time, and the joint PPDU time can be used to determine PPDU duration boundary and scheme selection. In addition, the processor may generate aggregations in sequence or by an interleaving manner, to make the PPDU length align with the aggregation behavior.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method applied in multiple link operations of an electronic device, wherein the electronic device is communicated with another electronic device by using a first link and a second link, and the method comprises:
determining a maximum aggregation length of a plurality of packets;
using the maximum aggregation length of the plurality of packets, a data rate of the first link and a data rate of the second link to calculate a joint physical layer protocol data unit (PPDU) time;
aggregating first packets of the plurality of packets in sequence to form a first aggregation based on the joint PPDU time;
aggregating second packets of the plurality of packets in sequence to form a second aggregation based on the joint PPDU time; and
simultaneously transmitting the first aggregation and the second aggregation by using the first link and the second link, respectively.

2. The method of claim 1, wherein the step of determining the maximum aggregation length of the plurality of packets comprises:
recording a length of each of the plurality of packets and accumulating the lengths of the plurality of packets to determine the maximum aggregation length of the plurality of packets.

3. The method of claim 1, wherein the step of determining the maximum aggregation length of the plurality of packets comprises:
using a queue length of the plurality of packets and a number of the plurality of packets to estimate the maximum aggregation length of the plurality of packets.

4. The method of claim 3, wherein the step of using the queue length of the plurality of packets and the number of the plurality of packets to estimate the maximum aggregation length of the plurality of packets comprises:
using the queue length of the plurality of packets and the number of the plurality of packets to calculate an average length of each of the plurality of packets; and
multiplying the average length of each of the plurality of packets by a block acknowledgment window to generate the maximum aggregation length of the plurality of packets.

5. The method of claim 1, wherein the step of determining the maximum aggregation length of the plurality of packets comprises:
determining an initial maximum aggregation length of the plurality of packets;
adjusting the initial maximum aggregation length of the plurality of packets by considering if an average length of the packet is less than a minimum media access control (MAC) start spacing (MMSS).

6. The method of claim 5, wherein the step of adjusting the initial maximum aggregation length of the plurality of packets by considering if the average length of each packet is less than the MMSS comprising:
determining an average length of the first packet;
if a length corresponding to the MMSS is greater than the average length of the first packet, calculating a first difference by subtracting the average length of the first packet from the length corresponding to the MMSS;
determining an average length of the second packet;
if the length corresponding to the MMSS is greater than the average length of the second packet, calculating a second difference by subtracting the average length of the second packet from the length corresponding to the MMSS; and
determining the maximum aggregation length of the plurality of packets by using the initial maximum aggregation length of the plurality of packets, the first difference, a number of the first packets, the second difference and a number of the second packets.

7. An electronic device, configured to perform steps of:
establishing a first link and a second link to communicate with another electronic device;
determining a maximum aggregation length of a plurality of packets;
using the maximum aggregation length of the plurality of packets, a data rate of the first link and a data rate of the second link to calculate a joint physical layer protocol data unit (PPDU) time;
aggregating first packets of the plurality of packets in sequence to form a first aggregation based on the joint PPDU time;
aggregating second packets of the plurality of packets in sequence to form a second aggregation based on the joint PPDU time; and
simultaneously transmitting the first aggregation and the second aggregation by using the first link and the second link, respectively.

8. The electronic device of claim 7, wherein the step of determining the maximum aggregation length of the plurality of packets comprises:
recording a length of each of the plurality of packets and accumulating the lengths of the plurality of packets to determine the maximum aggregation length of the plurality of packets.

9. The electronic device of claim 7, wherein the step of determining the maximum aggregation length of the plurality of packets comprises:
using a queue length of the plurality of packets and a number of the plurality of packets to estimate the maximum aggregation length of the plurality of packets.

10. The electronic device of claim 9, wherein the step of using the queue length of the plurality of packets and the number of the plurality of packets to estimate the maximum aggregation length of the plurality of packets comprises:
using the queue length of the plurality of packets and the number of the plurality of packets to calculate an average length of each of the plurality of packets; and
multiplying the average length of each of the plurality of packets by a block acknowledgment window to generate the maximum aggregation length of the plurality of packets.

11. The electronic device of claim 7, wherein the step of determining the maximum aggregation length of the plurality of packets comprises:
determining an initial maximum aggregation length of the plurality of packets;
adjusting the initial maximum aggregation length of the plurality of packets by considering if an average length of the packet is less than a minimum media access control (MAC) start spacing (MMSS).

12. The electronic device of claim 11, wherein the step of adjusting the initial maximum aggregation length of the plurality of packets by considering if the average length of each packet is less than the MMSS comprising:
determining an average length of the first packet;
if a length corresponding to the MMSS is greater than the average length of the first packet, calculating a first difference by subtracting the average length of the first packet from the length corresponding to the MMSS;
determining an average length of the second packet;
if the length corresponding to the MMSS is greater than the average length of the second packet, calculating a second difference by subtracting the average length of the second packet from the length corresponding to the MMSS; and
determining the maximum aggregation length of the plurality of packets by using the initial maximum aggregation length of the plurality of packets, the first difference, a number of the first packets, the second difference and a number of the second packets.

13. A method applied in multiple link operations of an electronic device, wherein the electronic device is communicated with another electronic device by using a first link and a second link, and the method comprises:
receiving a plurality of packets;
sequentially allocating the plurality of packets into a first aggregation and a second aggregation in an interleaving manner; and
simultaneously transmitting the first aggregation and the second aggregation by using the first link and the second link, respectively.

14. The method of claim 13, wherein the step of sequentially allocating the plurality of packets into the first aggregation and the second aggregation in the interleaving manner comprises:
for at least part of the plurality of packets:
if an accumulated length/airtime of the first aggregation is less than an accumulated length/airtime of the second aggregation, allocating the packet into the first aggregation; and
if the accumulated length/airtime of the first aggregation is greater than the accumulated length/airtime of the second aggregation, allocating the packet into the second aggregation.
